(19) United States
(12) Patent Application Publication
(10) Pub. No.: US 2007/0170969 A1
(43) Pub. Date: Jul. 26, 2007

(54) ELECTRONIC SYSTEM HAVING A CLOCK SIGNAL CORRECTING DEVICE

(75) Inventor: Michael Bernhard Sommer, Raubling (DE)

Correspondence Address: DICKE, BILLIG & CZAJA, FIFTH STREET TOWERS, 100 SOUTH FIFTH STREET, SUITE 2200, MINNEAPOLIS, MN, 55402, US

(73) Assignee: QIMONDA AG, Muenchen (DE)

(21) Appl. No.: 11/624,918

(22) Filed: Jan. 19, 2007

(30) Foreign Application Priority Data
Jan. 20, 2006 (DE) 10 2006 002 735.3

(51) Int. Cl. G06F 1/04

(52) U.S. Cl. 327/291

(57) ABSTRACT

An electronic system employing a clock signal correcting device is disclosed. One embodiment provides a leading edge delay device incrementing leading edges with respect to trailing edges, a trailing edge delay device incrementing trailing edges with respect to the leading edges, and a correction delay device delaying the leading edges of clock pulses if a leading edge incrementing step is greater than a trailing edge incrementing step and delaying the trailing edges of the clock pulses if the leading edge incrementing step is greater than the trailing edge incrementing step.

### CROSS-REFERENCE TO RELATED APPLICATIONS

This Utility Patent Application claims priority to German Patent Application No. DE 10 2006 002 735.3 filed on Jan. 20, 2006, which is incorporated herein by reference.

### BACKGROUND

The invention relates to an electronic system employing a clock signal correcting device.

A clock signal for clocking electronic systems, particularly for processing, transmitting or storing digital data, usually consists of a periodic sequence of pulses which is a result of a continuous change between two defined electrical potential levels which are usually designated by “H” (for “high”) and “L” (for “low”). Accordingly, the transitions from the L level to the H level are called “rising edges” and the transitions in the reverse direction (that is to say from the H level to the L level) are called “falling edges” of the clock signal. The “pulses” can be considered to be the times of the H level (H intervals T_{H}) or the times of the L level (L intervals T_{L}) as desired. In the first approach, which will be used as a basis for definition purposes in the text which follows, the rising edges can be considered as the leading edges of the pulses and the falling edges can be considered as the trailing edges of the pulses.

Clocking electronic circuits requires reliable detection and differentiation between the H intervals and the L intervals of the clock signal. It is desirable, therefore, that both intervals are long enough to allow the respective level to be detected. It is ideal if both intervals are equally long, that is to say are in each case exactly one half of the period T_{C} of the clock signal. That is to say the “duty cycle”, defined as the ratio between the pulse duration T_{H} and duration of the period T_{C} should be equal to ½.

This requirement must be met particularly in the case of high clock frequencies f_{C} (=1/T_{C}) because even small deviations of the duty cycle from the nominal value of ½ can here lead to the H intervals or the L intervals becoming too short and thus are no longer detected reliably. A system clock which is applied to a clock-controlled circuit and which has a “poor” duty cycle T_{H}/T_{C} not equal to ½ is often worsened even further internally in the circuit so that the internal synchronization to the external world can deteriorate fatally. The data eye of a falling clock edge is then displaced with respect to the data eye of a rising clock edge.

For the reasons mentioned above, duty cycle correction may be necessary. This is why many standards demand automatic duty cycle correction, normally abbreviated DCC, for circuits operating at a high data rate. This applies, e.g., to DRAM memory chips for DDR, DDR2 or DDR3 operation in which the data rate is twice or four times or eight times the frequency of the read and write clock.

The DCC has previously been implemented with the aid of a phase locked loop (PLL). In this concept, a voltage-controlled oscillator is calibrated to the frequency of the incoming clock signal. The oscillator has an almost perfect duty cycle equal to 1/2.The system clock with its poor duty cycle is replaced by the clock signal obtained from the oscillator. One problem is, however, the difficulty of accurately tuning the oscillator frequency to the frequency of the system clock.

For implementing a DCC is using a circuit which contains a delay locked loop (DLL). In this circuit, the clock signal and its inverted form are used. Both signals are displaced with respect to one another by a DLL in such a manner that the rising (or falling) edges come to coincide in time. When the duty cycle is not equal to 1/2, the other edges in each case do not appear at the same time. The different times are averaged by a mixer circuit. Both the mixer circuit and the DLL are very elaborate with respect to design and layout. Due to their complexity, this type of duty cycle correction is also very susceptible to errors.

There is a need for a correction of the duty cycle of a clock signal which can be implemented both reliably and in a very simple manner. For these and other reasons, there is a need for the present invention.

### SUMMARY

An electronic system employing a clock signal correcting device is provided. One embodiment provides a leading edge delay device incrementing leading edges with respect to trailing edges, a trailing edge delay device incrementing trailing edges with respect to the leading edges, and a correction delay device delaying the leading edges of clock pulses if a leading edge incrementing step is greater than a trailing edge incrementing step and delaying the trailing edges of the clock pulses if the leading edge incrementing step is greater than the trailing edge incrementing step.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of a possible embodiment of a duty cycle correction device according to the invention.

FIG. 2 illustrates the variation with time of the signals occurring in the device according to FIG. 1.

FIG. 3 illustrates a second embodiment, modified compared with FIG. 1, of a duty cycle correction device according to the invention.

FIG. 4 illustrates a third embodiment of a duty cycle correction device according to the invention.

FIG. 5 illustrates the basic configuration and the signals generated in an embodiment of a delay stage for edge delay.

FIG. 6 illustrates an exemplary embodiment of an oscillation testing device.

### DETAILED DESCRIPTION

In the following Detailed Description, reference is made to the accompanying drawings, which form a part hereof, and in which is illustrated by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In the figures, identical or similar elements (circuit sections and signals) are designated by the same letter combinations which are in each case followed by a numeric or general number for identifying the relevant element, the number “i” counting as representative for an arbitrary number. A colon between two numbers signifies the word “to”; thus, e.g., “A1:n” must be read as “A1 to An”. In the description below, the numbers “0” and “1” in inverted commas are used for designating binary states “logic values”.

The invention relates to an electronic system having a clock signal correcting device, the clock signal consisting of periodic pulses, with respect to deviations of the duty cycle from the nominal value of ½.The electronic system may further include an integrated circuit. One field of application of the invention is the duty cycle correction of the system clock signal in an electronic system, an integrated circuit, a logic system or memory system, in one example DRAM memory chips.

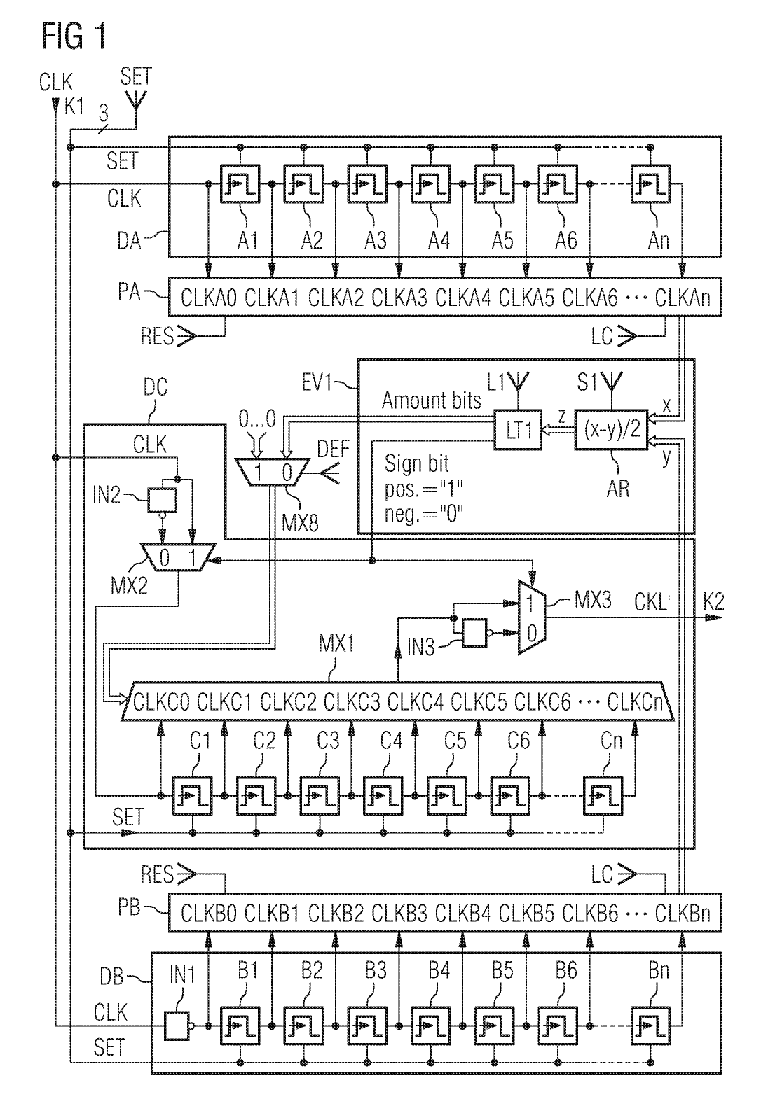

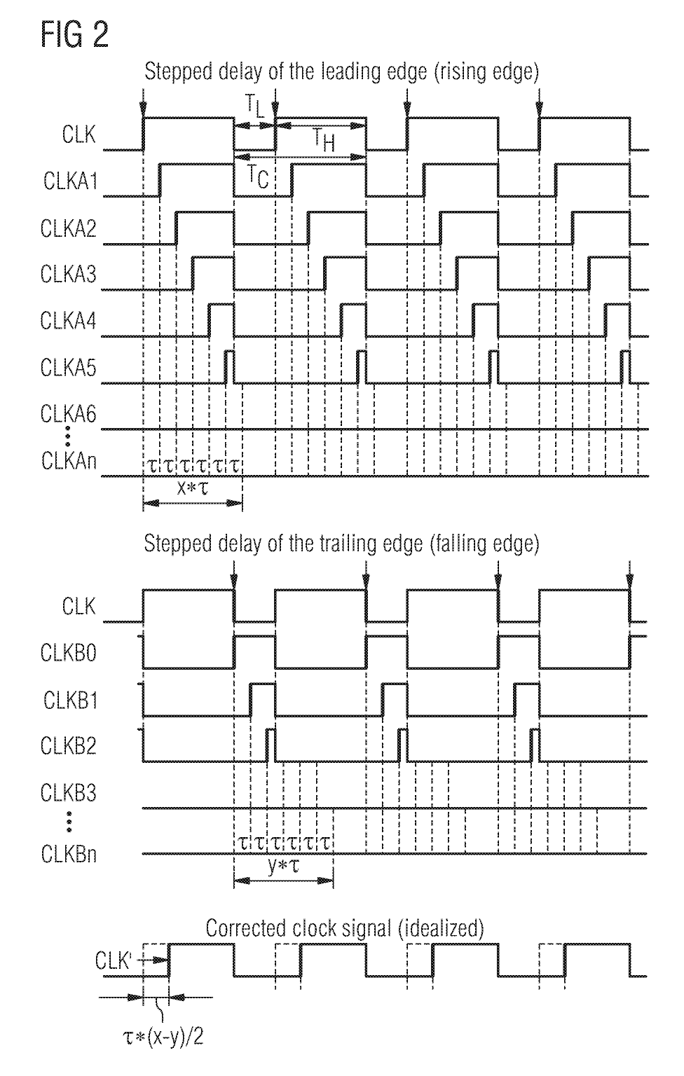

The device according to FIG. 1 has an input terminal K1 for applying the original clock signal to be corrected, and an output terminal K2 at which the corrected clock signal is supplied. The device contains a leading edge delay device DA, a trailing edge delay device DB, an evaluating device EV1 and a correction delay device DC. In the example illustrated, each of the delay devices DA, DB, DC contains a chain of n cascaded delay stages. The signal input of each delay device is connected for receiving the original clock signal CLK applied at the input terminal K1, which signal consists of a sequence of pulses as illustrated in FIG. 2.

Each clock pulse begins with a leading edge; in the representation used here, the leading edges are “rising” edges, i.e. transitions from the L level to the H level. The trailing edges at the ends of the pulses are accordingly the falling edges from the H to the L level. The edges have a finite steepness (not recognizable in FIG. 2); the “time” of an edge is usually understood to be the time at which the edge crosses through the center value between H and L level. The duration T_{H} from the time of the rising edge to the time of the next falling edge following forms the H interval (here: “pulse duration”), and the duration T_{L} from the time of the falling edge to the time of the next rising edge following forms the L interval (here: “pulse interval”). The period T_{C} of the clock signal is T_{H}+T_{L} and the duty cycle is defined as the quotient T_{H}/T_{C}=T_{H}/(T_{H}+T_{L}).

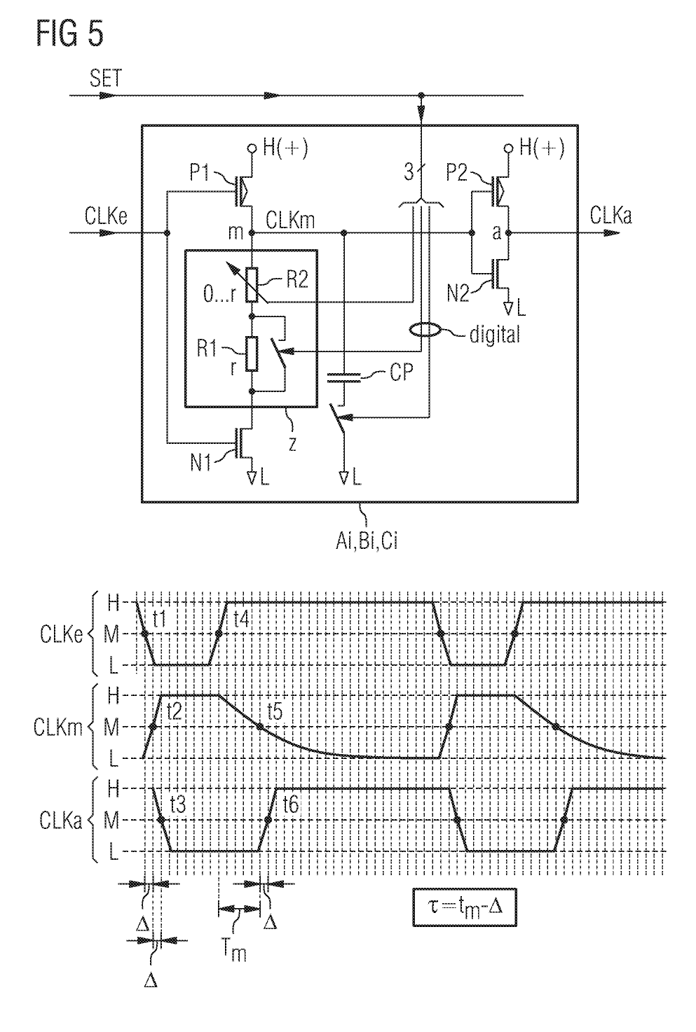

In the leading edge delay device DA according to FIG. 1, the clock signal CLK passes through the n-stage delay chain A1:n from stage to stage, in each one of which the rising edges are delayed by an increment τ with respect to the falling edges. A suitable circuit for such a delay stage will be described below in conjunction with FIG. 5. The incremental edge delay in the chain A1:n is illustrated in the top part of FIG. 2 by the wave forms CLKA1 to CLKAn which represent the signals at the outputs of the individual stages A1:n. The edes delayed or to be delayed in each case are drawn bold in FIG. 2.

In the delay chain A1:n, the H interval is thus increasingly shortened from stage to stage until it disappears completely at some time after passing through an xth stage Ax so that the signal remains at L level and accordingly no further oscillation is noticeable. The number x, that is to say the ordinal number of the delay incrementation at which the oscillation disappears is thus a relative measure of the “pulse duration” T_{H} in the clock signal CLK. The absolute measure of the pulse duration is τ*x.

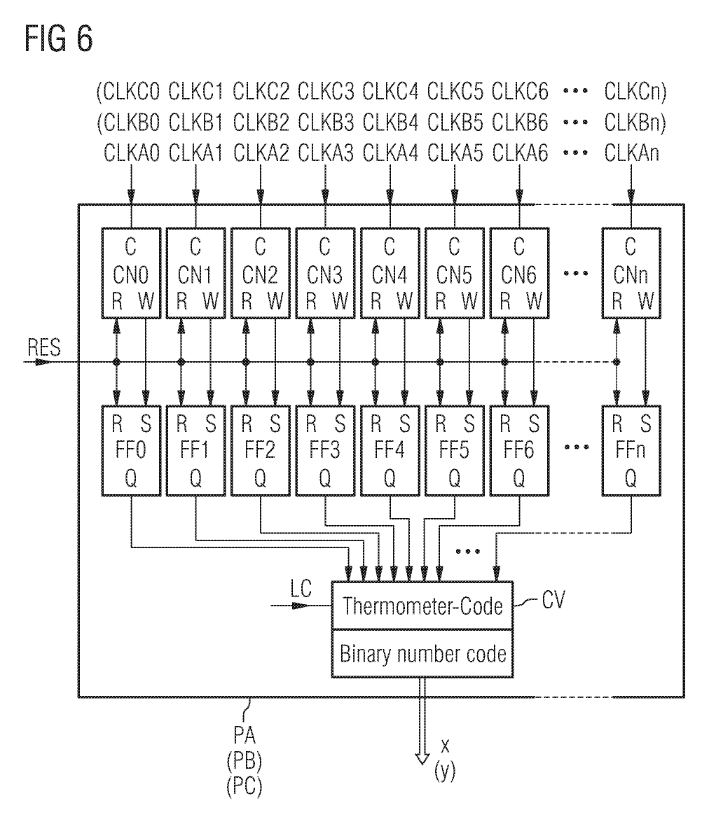

To determine the number x, a testing device PA is provided. This device PA receives the input signal CLKA0 of the first delay stage A1 which corresponds to the clock signal CLK, and the output signals CLKA1:n of the delay stages A1:n in order to test which of these signals regularly oscillate. The oscillation test is begun by placing a reset signal RES at the testing device into the inactive state “0”. There are many possibilities for sensing the existence of an oscillation in a signal, for example by detecting and counting pulse edges of the signal over a finite duration which includes some periods of the oscillation to be sensed. If a certain minimum count is reached within the duration, the signal can be evaluated as “oscillating”. An example of a testing device operating in accordance with this principle will be described below with reference to FIG. 6. A latch command LC at the testing device ends the test and ensures that the number x determined is stored (“latched”). The testing device PA supplies the number x in binary coded form, in binary number code consisting of a number of bits in parallel format.

The trailing edge delay device DB in the device according to FIG. 1 is used for deriving from the received clock signal CLK a plurality of signals CLKB1:n in which the trailing edges of the clock pulses are incrementally increasingly delayed in each case by the increment τ with respect to the leading edges. Although the trailing edges of the original clock signal are falling edges, a chain of delay stages B1:n in the delay device DB can be used which are constructed in the same manner as the delay stages A1:n, that is to say stages in which the rising edge is in each case delayed by τ with respect to the falling edge. This is possible by inverting the clock signal CLK by an inverter IN1 preceding the input of the chain B1:n.

FIG. 2 illustrates in the center section the variation of the original clock signal CLK, the wave form of the inverted clock signal CLKB0 at the input of the first stage B1 of the delay chain B1:n and below this the n signals CLK1:n at the outputs of the n stages B1:n. The edges to be delayed are also drawn bold in this case. In the delay chain B1:n, the H interval of the inverted clock signal CLKB0 is increasingly shortened from stage to stage until it has completely disappeared at some time after passing through a yth stage Ay so that the signal remains at L level and accordingly no further oscillation is noticeable. The number y, that is to say the ordinal number of the delay incrementation at which the oscillation disappears is thus a relative measure of the duration of the H interval in the inverted clock signal CLKB0, and thus of the duration of the L interval in the original clock signal CLK, that is to say the “pulse interval” T_{L} in the clock signal CLK. The absolute measure of the pulse interval is τ*y.

To determine the number y, a testing device PB is provided. This device PB receives the inverted clock signal CLKB0 and the output signals CLKB1:n of the delay stages B1:n in order to test which of these signals regularly oscillate. The testing device PB can be constructed in exactly the same manner as the testing device PA and supplies the number y in the same binary code form in which the number x is supplied.

The correction delay device DC can be controlled in dependence on the numerical values x and y determined in the testing devices in order to obtain by selectively delaying the leading edges or the trailing edges of the original clock signal CLK, a corrected clock signal CLK′ at the output terminal K2 in which the H intervals and the L intervals are matched to one another in order to match the duty cycle to the nominal value ½. If x is greater than y, that is to say the H intervals of the original clock signal CLK are longer than the L intervals T_{L}, the H intervals are shortened by delaying the leading edges (initiating these intervals). If y is greater than x, that is to say the L intervals of the original clock signal CLK are longer than the H intervals, the L intervals are shortened by delaying the trailing edges (initiating these intervals).

The information for adjusting the correction delay device DC is derived in the evaluating device EV1. The evaluating device EV1 contains an arithmetic computing circuit AR which can be activated by a computing command S1, in which circuit the numerical values x and y determined in the testing devices PA and PB are combined in order to obtain a digital representation of the value z=(x−y)/2 in which the amount |(x−y)/2| is expressed by a binary number having a number of bits and the sign is expressed by a sign bit. This representation is latched in a latch circuit LT1 by a latch command L1. The sign bit specifies whether the leading edges or the trailing edges of the clock signal CLK must be delayed in order to obtain the desired duty cycle ½. The amount value |(x−y)/2| specifies the number of time units τ by which the relevant edges must be delayed.

In order to adjust the correction delay device DC for correcting the duty cycle, it is supplied with the sign bit and the amount bits from the evaluating device EV1. In the case illustrated, a 2-1 multiplexer MX8 is provided on the path of the amount bits between the evaluating device and the correction delay device, which multiplexer can be switched over by a binary default control signal DEF in order to apply either the amount bits generated in the evaluating device or a bit combination representing the number zero to the correction delay device DC. If the correction device is to operate for correcting the duty cycle of the clock signal CLK at the input end as intended, the control signal DEF is set to “0” so that the amount bits generated in the evaluating device pass to the correction delay device DC.

In the correction delay device DC, too, a delay chain is used which consists of a plurality of cascaded delay stages C1:n. These stages are constructed exactly like the delay stages A1:n and B1:n. That is to say the chain C1:n, too, produces an incremental delay τ of the rising edges of a pulse sequence applied to the input from stage to stage.

In the correction operation as intended, DEF=“b 0” so that the amount bits representing the value |(x−y)/2| pass to the correction delay device DC. If the correction requires the leading edges (that is to say the rising edges) of the clock signal CLK to be delayed, which is indicated by a positive sign of the expression (x−y)/2, the clock signal in its original non-inverted version is used as input signal CLKC0 for the delay chain C1:n. If the correction requires the trailing edges to be delayed, which is indicated by a negative sign of the expression (x−y)/2, the clock signal in its inverted form is used as input signal CLKC0 for the delay chain C1:n. To select the version of the clock signal to be applied in each case, an input multiplexer MX2 is provided which can be controlled by the sign bit from the computing circuit AR in order to transmit either the non-inverted clock signal CLK or the inverted clock signal, conducted via an inverter IN2, to the input of the delay chain.

The signal CLKC0 applied to the input of the first stage C1 and the signals CLKC1:n appearing at the outputs of the stages C1:n are applied to n+1 inputs of an (n+1)-to-1 multiplexer MX1, the switching state of which is controlled in dependence on the integral component z=INT|(x−y)/2| of the value |(x−y)/2| from the amount bit output of the evaluating device EV1 in order to select from the signals CLKC0:n the one whose ordinal number within the chain corresponds to the integral number z which can also be equal to zero (if the duty cycle of the original clock signal corresponds sufficiently well to the nominal value ½). Accordingly, the selected signal CLKCz must pass through z delay stages C1:z and thus be subjected to a leading edge delay by τ*z. If z=0, the multiplexer MX1 selects the undelayed input signal CLKC0.

If x>y and thus the delay chain C1:n receives the original (non-inverted) clock signal CLK, the output signal of the multiplexer MX1 forms the corrected clock signal CLK′. If y<x, and the delay chain C1:n thus receives the inverted clock signal CLK, the output signal of the multiplexer MX1 forms the inverted form of the corrected clock signal CLK′ and requires further inversion in order to obtain the corrected clock signal CLK′. For this purpose, an output multiplexer MX3 is provided which can be controlled by the sign output of the computing circuit AR in order to transmit the signal CLKCz selected by the multiplexer MX1 either directly or via an inverter IN3 to the final output of the correction device.

In the lower part of FIG. 2, the corrected clock signal CLK′ is illustrated for the exemplary case where x>y and the leading edge therefore had to be delayed by the measure |(x−y)/2|. The wave form of the corrected clock signal illustrated in FIG. 2 is idealized inasmuch as certain delay influences and certain inaccuracies, which will be explained in greater detail in the text which follows, are not taken into consideration in the representation.

If desired, the duty cycle correction can be disabled by setting the default control signal DEF to a logical “1”. In this case, the control input of the multiplexer MX1 receives the numerical value zero via the multiplexer MX8 so that the output signal of the multiplexer MX1 does not have any edge delay. The duty cycle of the clock signal CLK′ at the output K2 then remains unchanged equal to the duty cycle of the original clock signal CLK. This possibility may be of advantage if the correction device is a permanent component of a clock-controlled chip in order to operate this chip, if desired, in a standard mode (default mode) without duty cycle correction of the clock signal. If the option of a default mode is to be omitted, the multiplexer MX8 can be omitted.

The delay stages A1:n, B1:n, C1:n in the delay devices DA, DB and DC produce not only a relative delay of the rising edges with respect to the falling edges (or conversely, depending on the design), but additionally also a delay of the total signal. Furthermore, processing the signals in the testing devices PA and PB and processing the test results x and y up to obtaining the control signals for the multiplexers MX1, MX2, MX3 require a certain time. This leads to the corrected clock signal CLK′ appearing to be displaced overall with respect to the original clock signal CLK. However, this does not impair the quality of the duty cycle correction.

On the other hand, however, there are circumstances which influence the quality of the correction, that is to say its accuracy. Such a circumstance is that a duty cycle of exactly ½ will be obtained in the corrected clock signal only when the amount of the correcting edge delay is exactly equal to the amount of (T_{H}−T_{L})/2. However, the testing devices PA and PB only supply the values of T_{H} and T_{L} as integral multiples x and y, respectively, of the time unit τ. In addition, the measure of possible correction delay is restricted to integral multiples INT|(x−y)/2| of the time unit τ. Thus, a certain inaccuracy can occur in the correction delay within a range of about ]−τ, +τ[. However, this inaccuracy can be kept within a tolerable limit by making τ sufficiently small with respect to the clock period T_{C}.

For the above reason, the time unit τ should be dimensioned in such a manner that a certain minimum number of time units τ is applicable to the period T_{C} of the clock signal even at the highest clock frequency to be expected. This minimum number, which also determines the number n of required stages in the delay chains, is dependent on the desired accuracy of the duty cycle correction. Making the time unit τ very short as would be appropriate for high clock frequencies, would however be disadvantageous in the case of a much lower clock frequency because the number n needed at delay stages in the individual chains would then be much too high. To solve this problem, the delay stages A1:n, B1:n and C1:n, in an embodiment, are constructed in such a manner that the delay unit τ, that is to say the measure of edge delay in each stage, can be adjusted by a control signal SET as will be described below in conjunction with FIG. 5.

A further reason for any inaccuracies can be that the time increment τ of the incremental edge delay is not precisely the same in all delay chains A1:n, B1:n, C1:n. Due to production tolerances and different layout conditions, small mismatches can also occur between the delay chains which leads to the duty cycle correction in the signal CLK′ not being optimal but having a residual error.

If this residual error cannot be tolerated, it can be reduced by subjecting the corrected clock signal to a repeated duty cycle correction. For this “post correction”, the output K2 of the correction device according to FIG. 1 can be connected to the clock signal input of a second correction device of the same type of construction. A less elaborate alternative consists in only providing the correction delay device DC twice and connecting its clock signal input to the output K2. In this case, a switch-over would have to be performed after the first correction which is carried out by the device according to FIG. 1 in the manner described above, in order to apply the corrected clock signal CLK′ from the output K2 to the delay devices DA and DB instead of the original clock signal CLK and to connect the x and y outputs of the testing devices DA and DB to the x and y inputs of the second correction delay device.

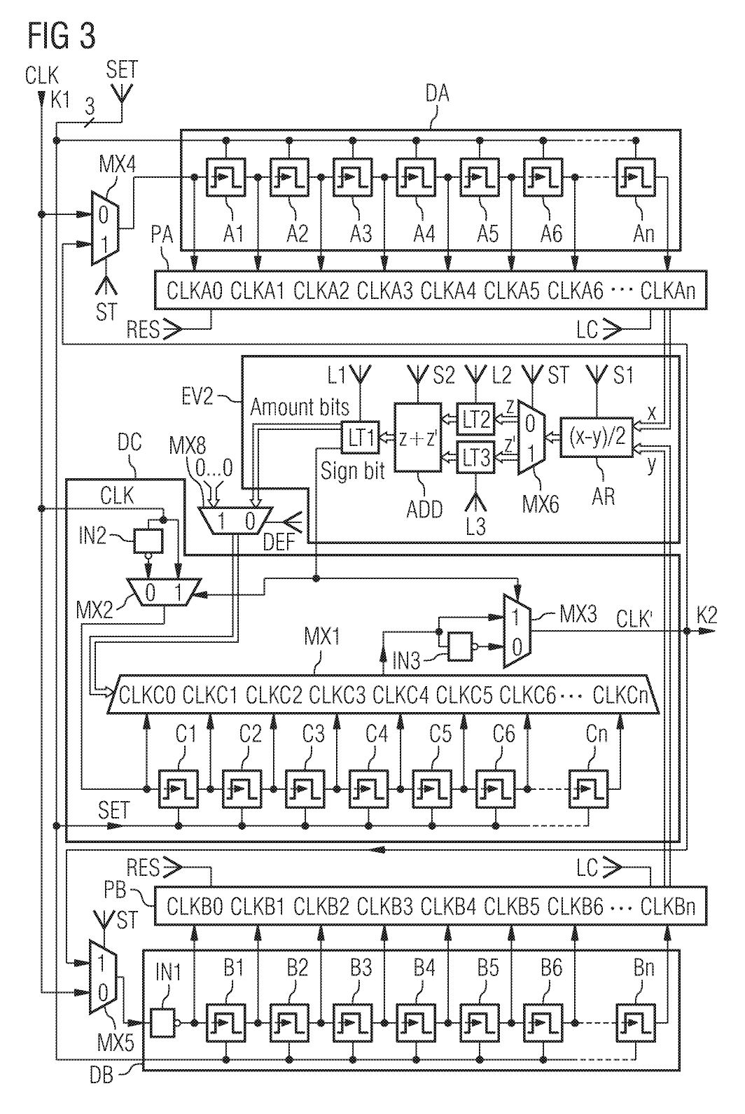

However, it is also possible to use the same correction device for the first correction and the subsequent post correction. FIG. 3 illustrates the block diagram of a construction of the correction device suitable for this purpose.

The device according to FIG. 3 differs from the device according to FIG. 1 by a few additions. On the one hand, the signal inputs of the leading edge delay device DA and the trailing edge delay device DB are in each case preceded by a changeover switch (multiplexer) MX4 and MX5, respectively, which can be switched over by a binary operating mode control signal ST in order to apply either the original clock signal CLK or the clock signal CLK′ derived from the output K2 to the relevant delay device. On the other hand, a modified evaluating device EV2 is provided which differs from the evaluating device EV1 according to FIG. 1 in that an arrangement containing a demultiplexer MX6 controllable by the signal ST followed by two latch circuits LT2, LT3 and a digital adder ADD is additionally inserted between the computing device AR and the latch circuit L1.

The device according to FIG. 3 can be switched over between two operating states via the signal ST which is supplied by a mode control device (“state machine”) (not illustrated). In both operating states, the correction delay device DC receives the original clock signal CLK. In the first operating state (logic state “0” of the signals ST), the delay devices DA and DB also receive the original clock signal CLK and the numerical values x and y are determined by the testing devices PA and PB and from these the value z=INT[(x−y)/2] is calculated in amount and sign in the computing device AR as has been described in conjunction with FIG. 1. This value passes via the 0 output of the demultiplexer MX6 to the latch circuit LT2 where it is latched by a latch command L2. The 1 output of the demultiplexer MX6 remains deactivated so that it supplies the numerical value 0 which is latched in the latch circuit LT3 by the latch command L3. A subsequent adding command S2 activates the adder ADD which supplies the sum of the values z and 0 latched in the latch circuits LT2 and LT3, that is to say the value z, which is then latched in the latch circuit LT1 by the latch command L1.

The amount bits and the sign bit of this value z from the output of the latch circuit L1 then control the multiplexers MX1, MX2, MX3 in the correction delay device DC as has been described above in conjunction with FIG. 1 in order to supply the corrected clock signal CLK′ at the output K2.

This is followed by the post correction of the signal CLK. For this purpose, the second operating state is switched on (logic state “1” of the signal ST). During this process, the delay devices DA and DB receive the clock signal CLK′ from the output K2, the settings of the multiplexers MX1:3 in the correction delay device DC initially remaining unchanged. Since it is thus no longer the original clock signal but the corrected clock signal which is processed in the testing devices PA and PB, new values x′ and y′ reflecting the duty ratio in the corrected clock signal CLK′ are obtained for the numbers x and y. The computing circuit AR thus calculates a new value z′=INT[(x′−y′)/2]. The sign and the amount of this value indicate what edges of the corrected clock signal CLK′ would have to be delayed by how many time units τ in order to eliminate the residual error of the correction.

However, since the correction delay device DC does not process the signal CLK′ but the original clock signal CLK, the value z′ cannot determine the new setting of the edge delay by itself. Instead, the previously set edge delay, by which the signal CLK′ was generated, must also be taken into consideration. That is to say the determining factor for the new edge delay is the sum of the value z′ and of the value z determined in the first operating state.

To obtain this sum z+z′, the value z′ is transmitted via the 1 output of the demultiplexer MX6 to the latch circuit LT3, where it is latched by the latch command L3, in the second operating state (logic value “1” of the control signal ST). The 0 output of the demultiplexer MX6 remains deactivated so that it supplies the numerical value 0 to the latch circuit LT2 to which, however, no latch command is applied this time so that the previous value z is retained at the output of this latch circuit. The subsequent control command SA activates the adder ADD which supplies the sum of the values z and z′ latched in the latch circuits LT2 and LT3. This sum z+z′ is then latched in the latch circuit LT1 by the latch command L1.

The amount bits and the sign bit of this value z+z′ from the output of the latch circuit L1 then control the multiplexers MX1, MX2, MX3 in the correction delay device DC in such a manner that the post corrected clock signal is obtained at the output K2.

The device capable of post correction according to FIG. 3 can also be modified by omitting the change-over switches MX4 and MX5 and instead connecting the inputs of the leading edge and trailing edge delay devices DA and DB firmly and permanently only to the output K2. In this case, a switch-over device (not illustrated) must be provided at the control input of the multiplexer MX1, which temporarily causes the multiplexer MX1 to select the undelayed signal CLKC0 when the control signal ST has the logic value “0”, at least until the value z has been latched in the latch circuit L2. Following this, for the remainder of the duration of the “0” state of the control signal ST, the switch-over device ensures that the amount bits of the value z are applied to the control input of the multiplexer.

In the embodiments according to FIG. 1 and FIG. 3, two separate delay chains A1:n and B1:n and two separate testing devices PA and PB are provided which can be operated simultaneously in order to supply the numbers x and y in parallel operation. An alternative consists in determining the numbers x and y after one another by the same delay chain and the same testing device. For this purpose, a suitable switching device (state machine) would have to be provided which applies the clock signal CLK to be corrected to the delay chain for determining the number x and applies the inverted clock signal to the delay chain for determining the number y. Such an arrangement would make it possible to save one delay chain and one testing device.

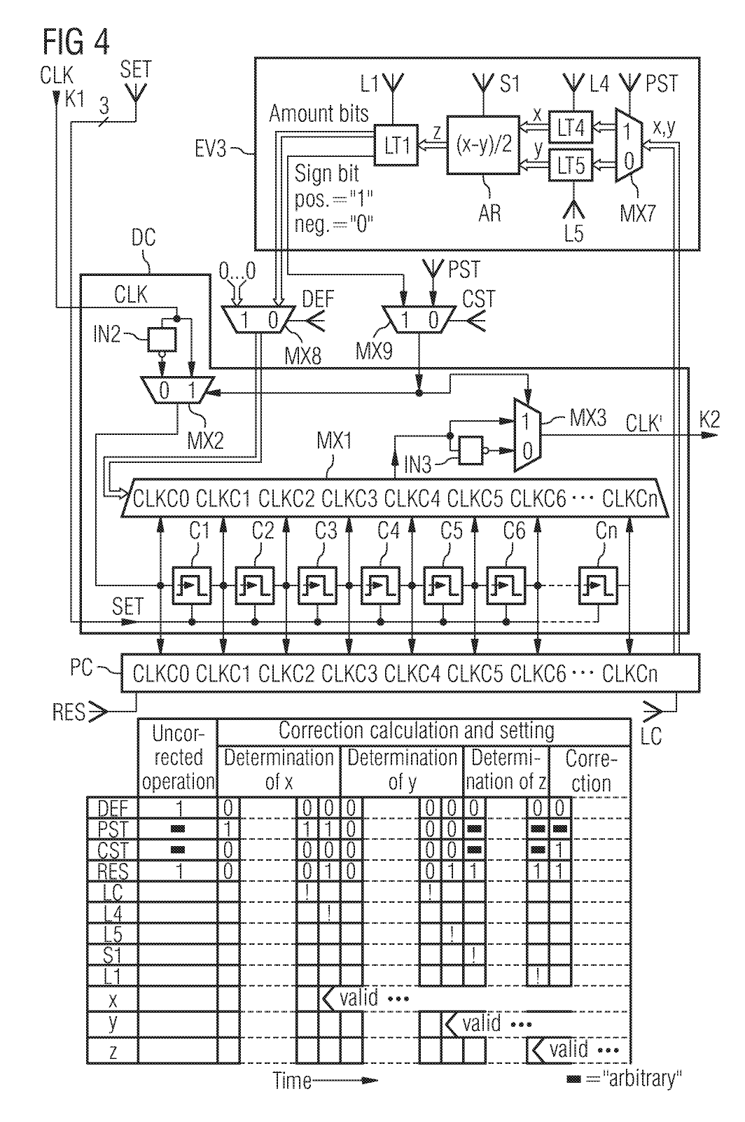

In addition, it is also possible to manage with only a single delay chain by using the delay chain C1:n used in the correction delay device DC for determining both the number x and the number y. In addition, using one and the same delay chain for all delay processes guarantees that the time unit τ which determines the increments of the delays is exactly the same in the various delay processes. In this case, no post correction of the corrected clock signal is needed. An example of a correspondingly constructed duty cycle correction device will be described with reference to FIG. 4 in the text which follows.

The device according to FIG. 4 contains only a single delay device DC which is constructed exactly like the correction delay device DC illustrated in FIG. 1. Furthermore, only a single testing device PC is provided which is constructed exactly like each one of the testing devices PA, PB according to FIG. 1. The n+1 inputs of this testing device PC receive the undelayed input signal CLKC0 of the first stage C1 and the n incrementally delayed output signals of the stages C1:n of the delay chain of the delay device DC. Furthermore, an evaluating device EV3 is provided which differs from the evaluating device EV1 according to FIG. 1 in that a series/parallel converter consisting of a demultiplexer MX7 and two latch circuits LT4, LT5 is provided preceding the two x and y inputs of the computing circuit AR. Between the evaluating circuit EV3 and the delay device DC, in addition to the amount bit multiplexer MX8, a second multiplexer M9 is provided in order to apply either the sign bit from the evaluating device EV3 or a test mode control bit PST to the control inputs of the two multiplexers MX2 and MX3 in the correction delay device DC.

To illustrate the operation of the correction device according to FIG. 4, a diagram showing the effectiveness of various control signals and commands in the course of time in successive operating phases of the correction device in table form is illustrated at the bottom of this figure. The individual columns are successive time steps, e.g., controlled by some suitable timing signal. As usual, the binary values of the control signals are represented by the digits “0” and “1”. The thick bar means that the signal value in the relevant time interval can be arbitrary, i.e. is without significance (“don't care”). The exclamation mark “!” signifies the activation of a command (e.g., the appearance of a triggering command signal edge). In the last three rows of the diagram, the times of validity of the numerical values x and y and z are illustrated.

In default mode, in which the duty cycle correction is intended to be disabled (uncorrected operation), the testing device PC is kept inactive by the active state (logic value “1”) of the reset signal RES. The default control signal DEF is kept at “1” so that the control input of the multiplexer MX1 receives the numerical value zero in order to transmit the original clock signal CLK to the output K2 without change in the duty cycle. In this connection, the state of the binary control signal for the multiplexers MX2 and MX3 is irrelevant.

When the correction device is operated as intended, that is to say for correcting the duty cycle of the input clock signal CLK, the default control signal DEF at the multiplexer MX8 is set to “0” so that the amount bit output of the evaluating device EV3 is connected to the control input of the multiplexer MX1 in the delay device DC. The correction operation includes four successive operating sequences, namely firstly the determination of the number x, secondly the determination of the number y, thirdly the determination of the number z=(x−y)/2 and fourthly the actual correction operation, that is to say the setting of the correcting edge delay.

To determine the number x, the reset signal RES is disabled, that is to say set to “0”, at the testing device PC. A correction mode signal CST is set to “0” and a test mode signal PST is set to “1”. The multiplexer MX9 herewith changes to a state in which it applies a “1” to the control inputs of the multiplexer MX2 and MX3 so that the delay chain C1:n receives the non-inverted clock signal CLK. In this operating state, the delay chain C1:n and the testing device PC operate in the same manner as has been described above for the delay chain A1:n and the testing device PA according to FIG. 1. After a certain testing period needed by oscillation testing of the signals CLKC0:n in the testing device PC for determining the number x, the latch command LC is issued by which the numerical value x is latched in the testing device PC. This numerical value x passes via the demultiplexer MX7, which is in the switch state “1” due to the controlling test mode bits PST=“1”, to the input of the latch circuit LT4 where it is latched as “valid” (that is to say stored) by a subsequent latch command L4. At the same time as the latch command L4, the reset signal RES is reset to “1” at the testing device PC.

To determine the number y, the reset signal RES is reset to “0” at the testing device PC. The correction mode signal CST remains set to “0” and the test mode signal PST is set to “0”. The multiplexer MX9 herewith passes into a state in which it applies a “0” to the control inputs of the multiplexers MX2 and MX3 so that the delay chain C1:n receives the inverted clock signal CLK. In this operating state, the delay chain C1:n and the testing device PC operate in the same manner as has been described above for the delay chain B1:n and the testing device PB according to FIG. 1. After a certain testing period which is needed by oscillation testing of the signals CLKC0:n in the testing device PC in order to determine the number y, the latch command LC is issued again by which the numerical value y is latched in the testing device PC. This numerical value y passes via the demultiplexer MX7 which is in the switch state “0” due to the controlling test mode bit PST=“0”, to the input of the latch circuit LT5 where it is stored as “valid” by a subsequent latch command L5. At the same time as the latch command L5, the reset signal RES is reset to “1” at the testing device PC.

To determine the numerical value z, RES remains set to “1” and the computing command S1 is issued so that the computing device AR calculates the value z=(x−y)/2 from the values x and y stored in the latch circuits LT4 and LT5. After a certain computing time has elapsed, the latch command L1 is issued so that the amount bits and the sign bit of the calculated number z are latched as “valid” in the latch circuit L1.

As a last step, the actual correction of the duty cycle takes place by the correction mode signal CST being set to “1” so that the multiplexer MX9 applies the sign bit of the calculated number z to the control inputs of the multiplexers MX2 and MX3. In this state, the correction delay device PC operates exactly as has been described above in conjunction with FIG. 1 in order to set the multiplexers M1, M2, M3, under control by the amount bits and the sign bit from the evaluating circuit, in such a manner that the clock signal CLK′ appears with the desired duty cycle ½ at the output K2.

The present switching state of the correction device remains unchanged during the subsequent useful operation of a clock-controlled device connected to the output K2. For any new correction of the duty cycle of the clock signal which may be desired, all operating sequences described are repeated, beginning with the determination of x.

As already announced, exemplary embodiments of the delay stages in the delay devices DA, DB, DC and of the associated testing devices PA, PB, PC will be described with reference to FIG. 5 and FIG. 6 in the text which follows.

FIG. 5 illustrates the circuit diagram of a possible embodiment of an adjustable delay stage which can be used for each stage Ai, Bi, Ci in the delay devices PA, PB, PC. The delay stage illustrated contains a first (inverting) binary amplifier as input amplifier with a P-channel field effect transistor (PFET) P1, the source of which is connected to H potential and the drain of which is connected via a variable impedance Z to the drain of an N-channel field effect transistor N1. The source of the NFET N1 is connected to L potential, and the gates of both transistors P1 and N1 are connected for receiving the input clock signal CLKe to be delayed. The output signal CLKm of the input amplifier appears at the circuit node “m” at the drain of the PFET P1.

The delay stage according to FIG. 5 also contains a second (inverting) binary amplifier as output amplifier with a PFET P2, the source of which is connected to H potential, and the drain of which is connected to L potential via the channel of an NFET N2. The gates of both transistors P2 and N2 are connected for receiving the output signal CLKm of the input amplifier. The output signal CLKa of the delay stage is derived at the interconnected drains of the transistors P2, N2 at the circuit node “a”.

The lower part of FIG. 5 is a timing diagram which illustrates the variation of the signals CLKe, CLKm and CLKa with time. With the falling edge of the input clock signal CLKe (time t1), the previously conducting NFET N1 is cut off and the PFET P1 previously cut off conducts so that the circuit point m is pulled up from L potential to H potential and thus a rising edge appears in the signal CLKm. The steepness of this edge is determined by the time constant of the pull-up branch between the node m and the H terminal. This time constant is proportional to the forward resistance of the PFET P1 which should be as small as possible. This results in a small delay Δ between the falling edge of the input signal CLKe (time t1 of the transition through the center level (H+L)/2) and the resultant rising edge of the signal CLKm (time t2).

With the rising edge (time t2) of the input clock signal CLKe, the NFET N1 previously cut off conducts and the PFET P1 previously conducting is cut off so that the circuit point m is pulled down from H potential to L potential and thus a falling edge appears in the signal CLKm. The steepness of this edge is determined by the time constant of the pull-down branch between the node m and the L terminal. Due to the additionally inserted impedance Z, this time constant is noticeably greater than the time constant of the pull-up branch so that the falling edge is noticeably flatter than the rising edge. The falling edge thus reaches the center level M at a time t5 which, compared with the time t4 of the triggering rising edge of the signal CLKe, is delayed by a measure Tₘ which is noticeably greater than Δ.

The output amplifier formed with the transistors P2 and N2 operates similar to the input amplifier. There is, however, a difference in that not only the pull-up branch via transistor P2, but also the pull-down branch via transistor N2, has the lowest possible impedance in the conducting state of the respective transistor. Thus, the steep rising edge of the signal CLKm appearing at time t2 causes a steep falling edge in the output signal CLKa after a small delay time Δ at time t3. The flat falling edge of the signal CLKm causes a steep rising edge in the output signal CLKa, the time t6 of which is also delayed by only a small measure A compared with the time t5, i.e. compared with the time at which the flattened edge passes through the center level M. Since, however, time t5 is noticeably later than the time t2, the rising edge of the input signal CLKe appears in the output signal CLKa with noticeably more delay than the falling edge. This extra delay is (t6−t4)−(t3−t1)=(Tₘ+Δ)−2Δ=Tₘ−Δ and defines the time unit τ.

The greater the impedance z, the longer the time unit τ. To be able to adjust the time unit τ, this impedance can be varied by the control variable SET, e.g., as illustrated by a resistance chain, the individual resistances of which can be selectively activated or deactivated by associated switches. In the case illustrated, a fixed resistance R having the resistance value r and a controllable resistance R2 are provided, the resistance value of which can be varied continuously between 0 and r. This allows continuous adjustment of the total resistance between 0 and 2r by an analog signal for controlling the resistance R2 and by a binary signal for optionally activating the resistance R1.

In addition to pull-down resistances (or instead), one or more capacitances could also be provided between the circuit node m and the L potential, which can be optionally switched on and off. The higher the effective total capacitance, the longer the time τ. In FIG. 5, such a capacitance CP is drawn as example which can be optionally activated or deactivated by a second binary signal and a switch. Accordingly, the line for applying the control variable SET consists of a total of three wires in the case illustrated.

The embodiment of the variable pull-down impedance, illustrated in FIG. 5, is only one example. The number of resistances in the chain can be greater or less than 2 and, instead of the resistance controllable by analog means, a fixed resistance can also be provided depending on the grading in which the impedance Z and thus the quantity τ are to be variable. Instead of the series circuit illustrated, a parallel circuit of a number of controllable resistances and/or selectively activatable fixed resistances can also be provided. In practice, the resistances can be implemented by bipolar or field effect transistors as can the capacitances which may be used and also the switches as is usual particularly in the case of integrated circuits. It is also possible to provide a number of complete pull-down branches in parallel which can differ in their impedance and can be optionally switched on and off by control signals.

The delay time τ is adjusted in dependence on the clock frequency f_{C}, in such a manner that the product of this time by the number n of stages in each delay chain, that is to say the product τ*n, is not significantly smaller than the clock period T_{C}, approximately equal to the clock period.

FIG. 6 diagrammatically illustrates the structure of a possible and embodiment of the testing device PA for the leading edge delay device DA. The testing device illustrated contains a plurality of n+1 similar counters CN0:n and the same number of RS flip flops FF0:n which are individually allocated to the counters. The counter CN0 receives at its counting input C the clock signal CLKA0, and the counters CN1:n receive at their counting inputs C in each case one of the incrementally edge-delayed clock signals CLKA1 :n from the delay chain A1:n (FIG. 1). The counters CN0:n are constructed for counting edges of the same orientation (e.g., of the falling edges) of the received signals. Counting is started with the numerical value 0 after deactivation of a reset signal RES at the R inputs of the counters. The counters CNT0:n have a signal output W which supplies a logical “0” as long as the numerical value remains below a preselected threshold. As soon as this threshold value is reached, the W output switches to a logical “1”. As a result, the set input S of each associated RS flip flop is activated in order to place the flip flop into its “1” state so that it supplies a “1” at its Q output.

All counters CN0:1 are constructed in such a manner that the count stops when the upper counting limit is reached (overflow) and does not begin again from the beginning with the value 0.

Those counters CN0:(x−1), whose input signals regularly contain repetitive counting edges, that is to say “oscillate”, reach the threshold count within a certain counting period and set the associated flip flops FF0:(x−1). The remaining counters CNx:n, the input signals of which do not oscillate, ideally receive no counting pulses at all. That is to say, in the ideal case, these counters remain at 0. However, there can be slight disturbances, e.g., a certain jitter of the phase of the clock signal to be corrected, which lead to a certain fuzziness occurring at the boundary between oscillation and non- oscillation. Thus, a counting edge may appear from time to time in a signal which is no longer oscillating in the ideal case. Since these “outliers” are rarer than the counting edges of an unambiguously oscillating signal, the counts of the relevant counter will lag behind the counts of those counters receiving the unambiguously oscillating signals.

Thus, by suitably choosing the threshold count and the counting period, it can be achieved that after the counting period has elapsed, only those counters CN0:(x−1), the received signals of which oscillate, have reliably reached the threshold value and all other counters CNx:n have not. After the counting period has elapsed, the Q outputs of the first x flip flops FF0:(x−1) are therefore at “1” and the Q outputs of the remaining flip flops FFx:n are at “0”. Thus, the Q outputs of the flip flops FF0:n supply the number x in the “thermometer code” at the end of the counting period. This thermometer code word is latched at the input of a code converter CV by a latch command LC. The code converter CV provides for the conversion of the thermometer code representation into a binary number code representation of the number x.

The testing device PB for the trailing edge delay device DB can be constructed exactly as the testing device PA illustrated in FIG. 6 in order to determine the number y in thermometer code and then to represent it in binary number code. The testing device PB receives the inverted clock signal CLKB0 at the C input of the counter CN0 and the incremental edge-delayed signals CLKB0:n at the C inputs of the counters CN1:n. In the same manner, the testing device PC can also be constructed in the embodiment of the correction device according to FIG. 4 in order to receive the clock signals CLKC0:n at the C inputs of the counters CN0:n.

Naturally, the duration of the oscillation test in the testing devices PA and PB, that is to say the counting period for the counters contained in these devices, from the beginning of the counting operation (deactivation of the reset signal RES) to the sampling and latching of the flip flop outputs (latch command LC), should be dimensioned in such a manner that it includes a certain minimum number of periods Tc of the clock signal CLK in every case. This minimum number depends not only on the length of the time unit τ but also on various other factors such as the maximum propagation delay of the clock signals through the respective delay chain and the counter propagation delay and the relative frequency of the abovementioned “outliers” in the oscillation test. All these factors are production- and layout-related so that the minimum number mentioned would have to be found out empirically from case to case.

Naturally, the threshold count should not be smaller than the minimum number mentioned. The size of the counters, i.e. their counting capacity, can be dimensioned in such a manner that the final count can also be used as the threshold count at the same time. In this case, the signal to be generated at the counter terminal W is derived from the overflow indication of the counter.

In the embodiment of the testing devices PA and PB illustrated, an oscillation test of also the non-delayed clock signals CLK and CLKB0, respectively, takes place by the counter CN0 and of the flip flop FF0. If these signals do not oscillate in a clearly recognizable manner, the value 0 is obtained for the numbers x and y. This can be used for indicating that the clock signal is disturbed in an uncorrectable manner. If such an indication capability is to be dispensed with, the oscillation test of the undelayed clock signals CLK and CLKB0, respectively, can be omitted so that the counter CN0 and the flip flop FF0 in the testing devices PA and PB can be omitted. In this case, the outputs of the testing devices represent the numbers x-1 and y-1, respectively. However, this does not change anything in the mathematical result of the computing device AR because this result only depends on the difference between the two input numbers.

For the sake of completeness, it should also be mentioned that the various operating processes in the correction device are coordinated by suitable timing control which also controls the succession of the individual operations in time. This also includes the timed generation of the control and latch commands ST, L1, L2, L3, SA, RES and LC.

The circuits described above by the drawings are only examples for implementing the correction principle according to the invention. The invention is not restricted to these but can also be implemented in modified embodiments. Some of these modifications will be described briefly in the text which follows:

In the example described, the testing devices PA and PB contain a separate individually allocated oscillation detector (in each case formed by a counter CN and a flip flop FF) for each signal to be tested, and all signals to be tested are supplied in parallel to the relevant testing device. An alternative consists in providing for each testing device only a single oscillation detector to which the increasingly delayed signals are successively applied via a correspondingly controlled multiplexer. As soon as the detector senses the state “no oscillation in the signal”, the ordinal number x or y of the delay stage at which the oscillation disappears can be derived from the associated multiplexer setting. The multiplexer is to be provided at the outputs of the delay stages if the signal to be incrementally delayed is applied to the input of the delay chain. Such an arrangement with “output multiplexer” is then like the arrangement as illustrated in FIG. 1 for the delay chain C1:n and the multiplexer MX1. However, it is also possible to apply the respective input signal for the delay chains A1:n and B1:n step by step to the inputs of successive stages via the multiplexer (the multiplexer operating as demultiplexer in this case) so that the output of the last stage successively supplies the increasingly delayed signals which are then tested in the oscillation detector.

As an alternative, the delay chain C1:n in the correction delay device DC can also be operated with an input multiplexer operating as demultiplexer, instead of with the output multiplexer MX1 illustrated. The signal to be delayed is applied to the signal input of this input multiplexer in order to transmit it to the input of a selected stage in the delay chain C1:n. The selection is carried out by controlling the multiplexer in dependence on the amount bits which represent the number |(x−y)/2|, in such a manner that the signal appears at the output of the last stage Cn with the desired edge delay V=τ*|(x−y)/2|.

In principle, the device operates on the basis of two time measurements. With one measurement, the “pulse duration” is measured, i.e. the duration of the interval from the leading edge to the trailing edge of the pulse. With the other measurement, the time duration of the intervals between the clock pulses is measured, i.e. the “pulse intervals” from the trailing edge of the clock pulses to the leading edge of the following clock pulse in each case. Each of the two measurements are made by testing, by using a delay chain, the number of time units τ by which an edge which marks the beginning of the interval to be measured in each case in the clock signal must be delayed until it coincides with the next edge following and the oscillation of the signal thus disappears. From the two numbers obtained as a result of the two measurements it can be easily determined which edges of the clock signal (leading or trailing edges of the clock pulses) must be delayed by how many time units τ in order to correct the duty cycle to the desired nominal value.

The device operating in accordance with this principle does not need any precisely tunable oscillator. Since the time measurements are made with the aid of an incremental edge delay by a delay chain, the timing reference for the measurement, that is to say the time unit τ, is not determined by any frequency but is a delay time which can be adjusted to be almost arbitrarily short in order to achieve an arbitrary fineness of the time measurement. The presence or lack of an oscillation in the incrementally edge-delayed signals can be detected relatively simply. Both the results of the time measurements and the measure of the correcting edge delay determined from these appear as multiples of the same time unit τ which, in turn, is predetermined by the stage delay in the delay chains. It can be easily ensured that this stage delay is the same in all stages, also in the stages of the correction delay device so that the correction is always carried out with an accuracy within the range of ]−τ, +τ[.

The correction device can be used in conjunction with any clock-controlled device in order to correct the duty cycle of the clock signal used there. It can be connected directly before the clock input of such a device as external circuit unit or can be an internal or integrated component of the relevant device. If the clock-controlled device is an integrated memory chip, e.g., a DRAM chip, the correction device also integrated in the chip can be activated during the initialization phase of the chip in order to test the clock signal supplied externally and to determine the numbers x and y so that the correction delay device is adjusted for achieving the duty cycle of ½. This adjustment can then be retained during the subsequent useful operation until a new initialization is carried out. The initialization can take place automatically in each case when the chip is taken into operation and, if desired, can be repeated during the useful operation, either automatically at regular intervals or whenever the environmental conditions change in such a manner that a change in the duty cycle in the clock signal supplied externally must be suspected.

The preceding description describes exemplary embodiments of the invention. The features disclosed therein and the claims and the drawings can, therefore, be useful for realizing the invention in its various embodiments, both individually and in any combination. While the foregoing is directed to embodiments of the present invention, other and further embodiments of this invention may be devised without departing from the basic scope of the invention, the scope of the present invention being determined by the claims that follow

Although specific embodiments have been illustrated and described herein, it will be appreciated by those of ordinary skill in the art that a variety of alternate and/or equivalent implementations may be substituted for the specific embodiments illustrated and described without departing from the scope of the present invention. This application is intended to cover any adaptations or variations of the specific embodiments discussed herein. Therefore, it is intended that this invention be limited only by the claims and the equivalents thereof.

What is claimed is:

1. An electronic system comprising:
a clock signal correcting device comprising:
a leading edge delay device incrementing leading edges with respect to trailing edges;
a trailing edge delay device incrementing trailing edges with respect to the leading edges; and
a correction delay device delaying the leading edges of clock pulses if a leading edge incrementing step is greater than a trailing edge incrementing step and delaying the trailing edges of the clock pulses if the leading edge incrementing step is greater than the trailing edge incrementing step.

2. The system of claim 1 comprising:
an integrated circuit in communication with the clock signal correcting device.

3. The system of claim 2, comprising where the integrated circuit is a memory system.

4. The system of claim 1, comprising:
a logic system in communication with the clock signal correcting device.

5. The system of claim 1, comprising:
a first testing device monitoring the oscillation of the signals derived by the leading edge delay device and determining a leading edge incrementing step at which the oscillation disappears; and
a second testing device monitoring the oscillation of the signals derived by the trailing edge delay device and determining a trailing edge incrementing step at which the oscillation disappears.

6. The system as claimed in claim 1, comprising:
wherein the correction delay device is controlled in order to delay the leading edges of the clock pulses by the measure
V=τ*|x−y|/2
if x>y, and in order to delay the trailing edges of the clock pulses by the measure V if x<y.

7. The system as claimed in claim 6, comprising:
wherein the clock signal consists of periodic pulses, wherein the leading edge delay device contains a chain of n delay stages the leading edge delay device deriving from the clock signal n versions with a delay, incremented step by step by in each case one time unit τ, of the leading edges with respect to the trailing edges;
wherein the trailing edge delay device contains a chain of n delay stages in order to derive from the clock signal n versions with a delay, incremented step by step by in each case the time unit τ, of the trailing edges with respect to the leading edges;
wherein the first testing device monitors the oscillation of the signals derived by the leading edge delay device and determines the ordinal number x of the delay incrementation at which the oscillation disappears;
wherein the second testing device monitors the oscillation of the signals derived by the trailing edge delay device and determines the ordinal number y of the delay incrementation at which the oscillation disappears; and

8. The system as claimed in claim 7, comprising wherein the stages of the leading-edge delay chain and the stages of the trailing-edge delay chain are constructed identically in order to displace the edges going in a first direction by the time unit τ in each case with respect to the other edges, and
wherein an inverter inverts the clock signal, to be delayed step by step, before the input of one of the delay chains.

9. The system as claimed in claim 8, comprising wherein the leading-edge delay chain and the trailing-edge delay chain consist of one and the same delay chain, and
wherein a switch-over device inserts the delay chain optionally into the leading edge delay device or into the trailing edge delay device.

10. The system as claimed in claim 1,comprising:
a correction delay chain of a number of delay stages, each of which delays the edges, going in a selected direction, of an applied clock signal by the time unit τ with respect to the other edges;
a first selection device which is controlled in order to derive at the correction delay chain, that version of the applied clock signal, the edges of which are delayed by the measure τ*|x−y|/2;
a second selection device which applies the clock signal to be corrected or the inverted version of the clock signal to the correction delay chain in dependence on the sign of the difference (x−y).

11. An integrated circuit having a clock signal correcting device comprising:
a leading edge delay device incrementing step by step of leading edges with respect to trailing edges;
a trailing edge delay device incrementing step by step of the trailing edges with respect to the leading edges;
a first testing device monitoring the oscillation of the signals derived by the leading edge delay device and determining the leading edge incrementing step at which the oscillation disappears;
a second testing device monitoring the oscillation of the signals derived by the trailing edge delay device and determining the trailing edge incrementing step at which the oscillation disappears; and
a correction delay device delaying the leading edges of the clock pulses if leading edge incrementing step is greater than the trailing edge incrementing step and delaying the trailing edges of the clock pulses if leading edge incrementing step is greater than the trailing edge incrementing step.

12. The circuit as claimed in claim 11, comprising:
wherein the clock signal consists of periodic pulses, wherein the leading edge delay device contains a chain of n delay stages the leading edge delay device deriving from the clock signal n versions with a delay, incremented step by step by in each case one time unit τ, of the leading edges with respect to the trailing edges;
wherein the trailing edge delay device contains a chain of n delay stages in order to derive from the clock signal n versions with a delay, incremented step by step by in each case the time unit τ, of the trailing edges with respect to the leading edges;
wherein the first testing device monitors the oscillation of the signals derived by the leading edge delay device and determines the ordinal number x of the delay incrementation at which the oscillation disappears;
wherein the second testing device monitors the oscillation of the signals derived by the trailing edge delay device and determines the ordinal number y of the delay incrementation at which the oscillation disappears; and
wherein the correction delay device is controlled in order to delay the leading edges of the clock pulses by the measure
V=τ*|x−y|/2
if x>y, and in order to delay the trailing edges of the clock pulses by the measure V if x<y.

13. The circuit as claimed in claim 12, comprising wherein the stages of the leading-edge delay chain and the stages of the trailing-edge delay chain are constructed identically in order to displace the edges going in a first direction by the time unit τ in each case with respect to the other edges, and
wherein an inverter inverts the clock signal, to be delayed step by step, before the input of one of the delay chains.

14. The circuit as claimed in claim 13, comprising wherein the leading-edge delay chain and the trailing-edge delay chain consist of one and the same delay chain, and
wherein a switch-over device inserts the delay chain optionally into the leading edge delay device or into the trailing edge delay device.

15. The circuit as claimed in claim 11, comprising wherein the first testing device which monitors the oscillation of the signals derived by the leading edge delay device, and the second testing device which monitors the oscillation of the signals derived by the trailing edge delay device, consist of one and the same testing device, and
wherein a switch-over connects the testing device optionally to the leading edge delay device or to the trailing edge delay device.

16. The circuit as claimed in claim 12, comprising:
a correction delay chain of a number of delay stages, each of which delays the edges, going in a selected direction, of an applied clock signal by the time unit τ with respect to the other edges;
a first selection device which is controlled in order to derive at the correction delay chain, that version of the applied clock signal, the edges of which are delayed by the measure τ*|x−y|/2;
a second selection device which applies the clock signal to be corrected or the inverted version of the clock signal to the correction delay chain in dependence on the sign of the difference (x−y).

17. The circuit as claimed in claim 16, comprising a switch-over device successively adjusting two operating states,
wherein in the first form the uncorrected clock signal is present at the inputs of the leading edge delay device and the trailing edge delay device and the selection devices in the correction delay device are adjusted in accordance with the amount and the sign of the number z=INT[(x−y)/2], and
wherein in the second form the output signal of the correction delay device is present at the inputs of the leading edge delay device and of the trailing edge delay device and the selection devices in the correction delay device are adjusted in accordance with the amount and the sign of a number z+z′, wherein z′=INT[(x′−y′)/2] and wherein x′ and y′ are the numbers which are obtained instead of the numbers x and y in the second operating state.

18. The circuit as claimed in claims 13, comprising wherein the leading-edge delay chain and the trailing-edge delay chain and the correction delay chain consist of one and the same delay chain, and
wherein a switch-over device optionally inserts the delay chain into any of the leading edge delay device, the trailing edge delay device and the correction delay device.

19. The circuit as claimed in claim 11, comprising wherein the first testing device which monitors the oscillation of the signals derived by the leading edge delay device, and the second testing device which monitors the oscillation of the signals derived by the trailing edge delay device, consist of one and the same testing device,
and wherein a switch-over device switches the correction delay device into two alternative test modes, in one of which the delay device acts as leading edge delay device in order to allow the testing device to determine the number x, and in the other one of which the delay device acts as trailing edge delay device in order to allow the testing device to determine the number y.

20. The circuit as claimed in claim 12, comprising wherein the time unit τ is adjusted simultaneously at all delay stages.

21. The circuit as claimed in claim 20, comprising:
an input binary amplifier with a pull-up branch and a pull-down branch, wherein the forward impedance of one of these branches is controlled higher than the forward impedance of the other branch,
and an output binary amplifier with a pull-up branch and a pull-down branch, both of which have the same forward impedance.

22. The circuit as claimed in claim 21, comprising wherein an element, the resistance of which can be continuously varied by an analog signal, controls the forward impedance in the relevant branch of the input binary amplifier.

23. The circuit as claimed in claim 22, comprising wherein, for controlling the forward impedance, additionally at least one element of fixed resistance is provided which is optionally inserted into the relevant branch by a digital signal.

24. The circuit as claimed in claim 11, comprising wherein each testing device contains counting means which can be activated in order to count the falling or rising edges, appearing in the incrementally delayed versions of the clock signal, in each case over a selected duration and to indicate the existence of an oscillation if a preselected threshold count is reached within the selected duration.

25. The circuit as claimed in claim 24, comprising wherein the counting means in each testing device in each case contain an individually allocated counter for each of the incrementally delayed versions of the clock signal.

26. The circuit as claimed in claim 24, comprising wherein the counting means in each testing device contain only a single counter,
and a switching device successively applies the incrementally delayed versions of the clock signal to the counting input of the counter in each case for at least the preselected duration.

27. A clock signal correcting device comprising:
a leading edge delay device incrementing step by step of the leading edges with respect to the trailing edges;
a trailing edge delay device incrementing step by step of the trailing edges with respect to the leading edges;
a testing device monitoring the oscillation of the signals derived by the leading edge delay device and determining the leading edge incrementing step at which the oscillation disappears and monitoring the oscillation of the signals derived by the trailing edge delay device and determining the trailing edge incrementing step at which the oscillation disappears; a switch-over connecting the testing device optionally to the leading edge delay device or to the trailing edge delay device; and
a correction delay device delaying the leading edges of the clock pulses if leading edge incrementing step is greater than the trailing edge incrementing step and delaying the trailing edges of the clock pulses if leading edge incrementing step is greater than the trailing edge incrementing step.

28. The device as claimed in claim 27, comprising:
wherein the clock signal consists of periodic pulses, wherein the leading edge delay device contains a chain of n delay stages the leading edge delay device deriving from the clock signal n versions with a delay, incremented step by step by in each case one time unit τ, of the leading edges with respect to the trailing edges;
wherein the trailing edge delay device contains a chain of n delay stages in order to derive from the clock signal n versions with a delay, incremented step by step by in each case the time unit τ, of the trailing edges with respect to the leading edges;
wherein the testing device monitors the oscillation of the signals derived by the leading edge delay device and determines the ordinal number x of the delay incrementation at which the oscillation disappears and monitors the oscillation of the signals derived by the trailing edge delay device and determines the ordinal number y of the delay incrementation at which the oscillation disappears; and
wherein the correction delay device is controlled in order to delay the leading edges of the clock pulses by the measure
V=τ*|x−y|/2
if x>y, and in order to delay the trailing edges of the clock pulses by the measure V if x<y.

29. The device as claimed in claim 28, comprising wherein the stages of the leading-edge delay chain and the stages of the trailing-edge delay chain are constructed identically in order to displace the edges going in a first direction by the time unit τ in each case with respect to the other edges, and
wherein an inverter inverts the clock signal, to be delayed step by step, before the input of one of the delay chains.

30. The device as claimed in claim 29, comprising wherein the leading-edge delay chain and the trailing-edge delay chain consist of one and the same delay chain, and
wherein a switch-over device inserts the delay chain optionally into the leading edge delay device or into the trailing edge delay device.

31. The device as claimed in claim 28, comprising:
a correction delay chain of a number of delay stages, each of which delays the edges, going in a selected direction, of an applied clock signal by the time unit τ with respect to the other edges;
a first selection device which is controlled in order to derive at the correction delay chain, that version of the applied clock signal, the edges of which are delayed by the measure τ*|x−y|/2;
a second selection device which applies the clock signal to be corrected or the inverted version of the clock signal to the correction delay chain in dependence on the sign of the difference (x−y).

32. The device as claimed in claim 31, comprising a switch-over device successively adjusting two operating states,
wherein in the first form the uncorrected clock signal is present at the inputs of the leading edge delay device and the trailing edge delay device and the selection devices in the correction delay device are adjusted in accordance with the amount and the sign of the number z=INT[(x−y)/2], and
wherein in the second form the output signal of the correction delay device is present at the inputs of the leading edge delay device and of the trailing edge delay device and the selection devices in the correction delay device are adjusted in accordance with the amount and the sign of a number z+z′, wherein z′=INT[(x′−y′)/2] and wherein x′ and y′ are the numbers which are obtained instead of the numbers x and y in the second operating state.

33. The device as claimed in claims 31, comprising wherein the leading-edge delay chain and the trailing-edge delay chain and the correction delay chain consist of one and the same delay chain, and
wherein a switch-over device optionally inserts the delay chain into any of the leading edge delay device, the trailing edge delay device and the correction delay device.

34. The device as claimed in claim 27, comprising wherein the switch-over device switches the correction delay device into two alternative test modes, in one of which the delay device acts as leading edge delay device in order to allow the testing device to determine the number x, and in the other one of which the delay device acts as trailing edge delay device in order to allow the testing device to determine the number y.

35. The device as claimed in claim 28, comprising wherein the time unit τ is adjusted simultaneously at all delay stages.

36. The device as claimed in claim 35, comprising wherein each delay stage contains the following:
an input binary amplifier with a pull-up branch and a pull-down branch, wherein the forward impedance of one of these branches is controlled higher than the forward impedance of the other branch,
and an output binary amplifier with a pull-up branch and a pull-down branch, both of which have the same forward impedance.

37. The device as claimed in claim 36, comprising wherein an element, the resistance of which can be continuously varied by an analog signal, controls the forward impedance in the relevant branch of the input binary amplifier.

38. The device as claimed in claim 37, comprising wherein, for controlling the forward impedance, additionally at least one element of fixed resistance is provided which is optionally inserted into the relevant branch by a digital signal.

39. The device as claimed in claim 27, comprising wherein the testing device contains counting means which can be activated in order to count the falling and rising edges, appearing in the incrementally delayed versions of the clock signal, in each case over a selected duration and to indicate the existence of an oscillation if a preselected threshold count is reached within the selected duration.

40. The device as claimed in claim 39, comprising wherein the counting means in the testing device in each case contain an individually allocated counter for each of the incrementally delayed versions of the clock signal.

41. An electronic system with a clock signal correcting device, the clock signal correcting device comprising:
a leading edge delay device incrementing step by step of leading edges with respect to trailing edges;
a trailing edge delay device incrementing step by step of the trailing edges with respect to the leading edges;
a first testing device monitoring the oscillation of the signals derived by the leading edge delay device and determining the leading edge incrementing step at which the oscillation disappears;
a second testing device monitoring the oscillation of the signals derived by the trailing edge delay device and determining the trailing edge incrementing step at which the oscillation disappears; and
a correction delay device delaying the leading edges of the clock pulses if leading edge incrementing step is greater than the trailing edge incrementing step and delaying the trailing edges of the clock pulses if leading edge incrementing step is greater than the trailing edge incrementing step.

42. The system as claimed in claim 41, comprising:
wherein the clock signal consists of periodic pulses, wherein the leading edge delay device contains a chain of n delay stages the leading edge delay device deriving from the clock signal n versions with a delay, incremented step by step by in each case one time unit τ, of the leading edges with respect to the trailing edges;
wherein the trailing edge delay device contains a chain of n delay stages in order to derive from the clock signal n versions with a delay, incremented step by step by in each case the time unit τ, of the trailing edges with respect to the leading edges;
wherein the first testing device monitors the oscillation of the signals derived by the leading edge delay device and determines the ordinal number x of the delay incrementation at which the oscillation disappears;
wherein the second testing device monitors the oscillation of the signals derived by the trailing edge delay device and determines the ordinal number y of the delay incrementation at which the oscillation disappears; and
wherein the correction delay device is controlled in order to delay the leading edges of the clock pulses by the measure
V=τ*|x−y|/2
if x>y, and in order to delay the trailing edges of the clock pulses by the measure V if x<y.

43. The system as claimed in claim 42, comprising wherein the stages of the leading-edge delay chain and the stages of the trailing-edge delay chain are constructed identically in order to displace the edges going in a first direction by the time unit τ in each case with respect to the other edges, and
wherein an inverter inverts the clock signal, to be delayed step by step, before the input of one of the delay chains.

44. The system as claimed in claim 43, comprising wherein the leading-edge delay chain and the trailing-edge delay chain consist of one and the same delay chain, and
wherein a switch-over device inserts the delay chain optionally into the leading edge delay device or into the trailing edge delay device .

45. The system as claimed in claim 41, comprising wherein the first testing device which monitors the oscillation of the signals derived by the leading edge delay device, and the second testing device which monitors the oscillation of the signals derived by the trailing edge delay device, consist of one and the same testing device, and
wherein a switch-over connects the testing device optionally to the leading edge delay device or to the trailing edge delay device.

46. The system as claimed in claim 42, comprising:
a correction delay chain of a number of delay stages, each of which delays the edges, going in a selected direction, of an applied clock signal by the time unit τ with respect to the other edges;
a first selection device which is controlled in order to derive at the correction delay chain, that version of the applied clock signal, the edges of which are delayed by the measure τ*|x−y|/2;
a second selection device which applies the clock signal to be corrected or the inverted version of the clock signal to the correction delay chain in dependence on the sign of the difference (x−y).

47. The system as claimed in claim 46, comprising a switch-over device successively adjusting two operating states,
wherein in the first form the uncorrected clock signal is present at the inputs of the leading edge delay device and the trailing edge delay device and the selection devices in the correction delay device are adjusted in accordance with the amount and the sign of the number z=INT[(x−y)/2], and
wherein in the second form the output signal of the correction delay device is present at the inputs of the leading edge delay device and of the trailing edge delay device and the selection devices in the correction delay device are adjusted in accordance with the amount and the sign of a number z+z′, wherein z′=INT[(x′−y′)/2] and wherein x′ and y′ are the numbers which are obtained instead of the numbers x and y in the second operating state.

48. The system as claimed in claims 43, comprising wherein the leading-edge delay chain and the trailing-edge delay chain and the correction delay chain consist of one and the same delay chain, and
wherein a switch-over device optionally inserts the delay chain into any of the leading edge delay device, the trailing edge delay device and the correction delay device.

49. The system as claimed in claim 41, comprising wherein the first testing device which monitors the oscillation of the signals derived by the leading edge delay device, and the second testing device which monitors the oscillation of the signals derived by the trailing edge delay device, consist of one and the same testing device,
and wherein a switch-over device switches the correction delay device into two alternative test modes, in one of which the delay device acts as leading edge delay device in order to allow the testing device to determine the number x, and in the other one of which the delay device acts as trailing edge delay device in order to allow the testing device to determine the number y.

50. The system as claimed in claim 42, comprising wherein the time unit τ is adjusted simultaneously at all delay stages.

51. The system as claimed in claim 50, comprising:
an input binary amplifier with a pull-up branch and a pull-down branch, wherein the forward impedance of one of these branches is controlled higher than the forward impedance of the other branch; and
an output binary amplifier with a pull-up branch and a pull-down branch, both of which have the same forward impedance.

52. The system as claimed in claim 51, comprising wherein an element, the resistance of which can be continuously varied by an analog signal, controls the forward impedance in the relevant branch of the input binary amplifier.

53. The system as claimed in claim 52, comprising wherein, for controlling the forward impedance, additionally at least one element of fixed resistance is provided which is optionally inserted into the relevant branch by a digital signal.

54. The system as claimed in claim 51, comprising wherein each testing device contains counting means which can be activated in order to count the falling or rising edges, appearing in the incrementally delayed versions of the clock signal, in each case over a selected duration and to indicate the existence of an oscillation if a preselected threshold count is reached within the selected duration.

55. The system as claimed in claim 54, comprising wherein the counting means in each testing device in each case contain an individually allocated counter for each of the incrementally delayed versions of the clock signal.

56. The system as claimed in claim 54, comprising wherein the counting means in each testing device contain only a single counter; and
a switching device successively applies the incrementally delayed versions of the clock signal to the counting input of the counter in each case for at least the preselected duration.

57. The system as claimed in claim 41, comprising being any of a memory system and a logic system.

58. The system as claimed in claim 41, comprising being a DRAM memory chip.

59. An electronic system comprising:
a clock signal correcting device comprising:
a leading edge delay device incrementing leading edges with respect to trailing edges;
a trailing edge delay device incrementing trailing edges with respect to the leading edges; and
means for providing a correction delay device delaying the leading edges of clock pulses if a leading edge incrementing step is greater than a trailing edge incrementing step and delaying the trailing edges of the clock pulses if the leading edge incrementing step is greater than the trailing edge incrementing step.
